(19) United States
(12) Patent Application Publication
(10) Pub. No.: US 2025/0233194 A1
(43) Pub. Date: Jul. 17, 2025

(54) RECHARGEABLE BATTERY WITH IMPROVED COOLING PERFORMANCE, RECHARGEABLE BATTERY PACK, AND MACHINE TOOL

(71) Applicant: Hilti Aktiengesellschaft, Schaan (LI)

(72) Inventors: Markus HARTMANN, Mauerstetten (DE); Robert STANGER, Kaufbeuren (DE); Johannes LANDESFEIND, Wielenbach (DE)

(21) Appl. No.: 18/699,109

(22) PCT Filed: Nov. 17, 2022
(86) PCT No.: PCT/EP2022/082217

§ 371 Date: Apr. 5, 2024

(30) Foreign Application Priority Data
Dec. 1, 2021 (EP) 21211564.6

(51) Int. Cl. H01M 10/0525; H01M 10/058; H01M 50/103; H01M 50/107; H01M 50/209; H01M 50/213; H01M 50/247

(52) U.S. Cl. CPC H01M 10/0525; H01M 10/058; H01M 50/103; H01M 50/107; H01M 50/209; H01M 50/213; H01M 50/247; H01M 2220/30

(57) ABSTRACT

A rechargeable battery for a machine tool, having a cell core is provided, wherein no point within the cell core is at a distance of more than 5 mm away from a surface of the rechargeable battery and the rechargeable battery has a capacity of at least 2.2 Ah. A battery pack and a machine tool are also disclosed.

### BACKGROUND OF THE INVENTION

The invention is based on a rechargeable battery for a machine tool. The rechargeable battery has a cell core.

Machine tools, for example electric power tools, which enable cordless operation, are increasingly being used. For this purpose, the machine tools have a rechargeable battery pack with at least one rechargeable battery. In order to be able to provide high outputs, the rechargeable battery pack and in particular the at least one rechargeable battery is discharged at a comparatively high discharge current. The rechargeable battery pack heats up during discharging due to the flow of the electric current, inter alia due to internal resistances in the rechargeable battery and/or in the rechargeable battery pack. However, excessive heating can lead to destruction by overheating or to a thermal runaway. A core temperature within the cell core should therefore always rise at most to a limit temperature.

Whether or how quickly this limit temperature is reached during discharging also determines the maximum possible discharging current and thus also the maximum output that can be drawn.

The object of the present invention is to provide a rechargeable battery, a rechargeable battery pack and a machine tool that can provide particularly high outputs.

The task is achieved by a rechargeable battery for a machine tool. The rechargeable battery has a cell core. No point within the cell core is at a distance of more 5 mm from a surface of the rechargeable battery. Thus, every point within the cell core is comparatively close to the surface. The rechargeable battery has a capacity of at least 2.2 Ah, preferably at least 2.5 Ah. The heat of the rechargeable battery that is generated in the cell core during discharging can thus be transported to the surface over a comparatively short distance. The heat can be dissipated from the surface. Such a rechargeable battery can therefore offer good cooling, in particular comparatively good autonomous cooling. The time period until the limit temperature is reached can be extended and/or the situation of the limit temperature being reached can advantageously be entirely avoided.

A comparatively homogeneous temperature distribution can be achieved within the cell core. This can result in uniform aging of the rechargeable battery. This in turn can increase the service life of the rechargeable battery.

These and other positive effects can become particularly evident if the rechargeable battery has a particularly large capacity. The capacity here can also be measured in Wh. For example, the rechargeable battery can have a capacity of at least 20 Wh, in particular at least 50 Wh, for example at least 200 Wh.

It is conceivable for the rechargeable battery to comprise lithium. For example, this can be a rechargeable lithium-ion battery.

A particularly advantageous heat dissipation and thus a high cooling capacity can result if a sectional area of the rechargeable battery is at least 40 cm², preferably at least 50 cm². The sectional area can be, for example, a longitudinal sectional area or a cross-sectional area. In the case of a cylindrical rechargeable battery, the sectional area can correspond to a cross-sectional area parallel to a base area of a cylinder inscribed by the rechargeable battery. In the case of a rectangular sectional area, the latter can be defined by a length and a corresponding width. “Rectangular” can also comprise a substantially rectangular shape. For example, a shape with radiused corners may be included.

The cooling of the rechargeable battery can be further improved if the surface area thereof is comparatively large in relation to its volume. A relatively large ratio can be understood, for example, to mean that a ratio of the surface area of the rechargeable battery to its volume is at least ten times greater than the reciprocal of the cube root of the volume.

One class of rechargeable batteries can be characterized in that the rechargeable battery, in particular the cell core, has a cylindrical shape. The cylindrical shape can have an ellipse and/or a polygon as the base area. The latter can also be and/or comprise a prism. “Cylindrical” can also comprise a substantially cylindrical shape. For example, the shape of the rechargeable battery can be cylindrical apart from unevenness on the end faces of the rechargeable battery, in particular apart from electrodes of the rechargeable battery.

It is also conceivable that the base area is configured so as to be annular. In general, the rechargeable battery, in particular the cell core, can be of tubular configuration. The rechargeable battery, in particular the cell core, can thus have a hollow interior. The hollow interior may have a largest diameter of at least 3 mm. The cell core can have a wall thickness. The wall thickness can be at most 14 mm, particularly preferably at most 7 mm, for example at most 5 mm.

The heat output generated in the cell core during discharging of the rechargeable battery can increase quadratically or at least substantially quadratically with the intensity of the discharge current.

A rechargeable battery which offers particularly good cooling as a result of the measures described is therefore particularly advantageous when high discharge currents are to be expected.

For example, the rechargeable battery can be specified to provide a discharge current of at least 20 A, in particular at least 25 A, over at least 10 s. In other words, the rechargeable battery can be specified to provide a continuous current of at least 20 A, in particular at least 25 A.

It is also conceivable that peak currents, in particular short-term peak currents, can lead to intense heating of the rechargeable battery. A rechargeable battery with powerful cooling, as can be achieved by the measures described here, is therefore particularly advantageous. It is conceivable, for example, that the rechargeable battery can provide at least 50 A for 1 second.

Machine tools can often require high outputs for a short period of time. A rechargeable battery that is able to provide such a peak current and/or such a continuous current can therefore be particularly suitable for such machine tools.

The scope of the invention also includes a rechargeable battery pack for a machine tool, comprising at least two rechargeable batteries. The rechargeable batteries can have one or more of the features described herein.

The battery pack can have up to 25 rechargeable batteries, for example. Such a rechargeable battery pack is conceivable, for example, in a portable machine tool, for example a hand-held power tool.

The battery pack can also have up to 100 rechargeable batteries. A rechargeable battery pack with more than 50 rechargeable batteries can be set up, for example, for use in a mobile machine tool, for example a construction robot.

A machine tool, comprising at least one rechargeable battery pack with the properties described herein and/or at least one rechargeable battery with the properties described herein, is also within the scope of the invention.

The machine tool can be specified for use on a construction site, for example a building construction site and/or a civil engineering construction site. Said machine tool can be configured for drilling, cutting, for example chiseling, sawing or cutting, pressing and/or grinding. Accordingly, the machine tool can be specified to accommodate a tool, for example a drilling tool, a cutting tool, for example a chisel tool, a saw blade or a knife, a pressing tool or a grinding tool, for example a grinding wheel.

Alternatively or additionally, it is conceivable that the machine tool is specified for suctioning, blowing and/or measuring. Accordingly, said machine tool can be specified to hold a tool in the form of a suction and/or a blowing tool, for example a suction and/or blowing tube, and/or a measuring tool.

The machine tool can be a mobile machine tool.

As a mobile machine tool, the machine tool may be portable. For this purpose, said machine tool can weigh at most 43 kg, particularly preferably at most 25 kg, in particular at most 10 kg, for example at most 5 kg. The machine tool can be an electric hand-held power tool, for example.

The term “mobile” can also include that the machine tool is specified to be temporarily fixed to a surface, for example for the purpose of carrying out construction work. Thus, for example, stand-operated hand-held power tools can also be included.

As an alternative or in addition to being portable, the machine tool can have a mobile platform. The mobile platform can have a chassis, for example a tracked chassis and/or a wheeled chassis.

In particular, the machine tool can also be designed as a construction robot. For this purpose, said machine tool can have a manipulator. An end effector can be disposed and-or configured on the manipulator. The end effector can be set up to receive the tool directly and/or indirectly. For example, the machine tool can be designed as a drilling construction robot, as a chisel construction robot and/or as a grinding construction robot.

Further features and advantages of the invention are derived from the following detailed description of exemplary embodiments of the invention, with reference to the figures of the drawing which shows details essential to the invention, and from the claims. The features shown therein are not necessarily to be understood as true to scale and illustrated in such a manner that the special features according to the invention can be made clearly visible. The various features can be implemented individually in their own right or collectively in any combinations in variants of the invention.

Exemplary embodiments of the invention are illustrated in the schematic drawing and explained in more detail in the following description.

In the drawing:

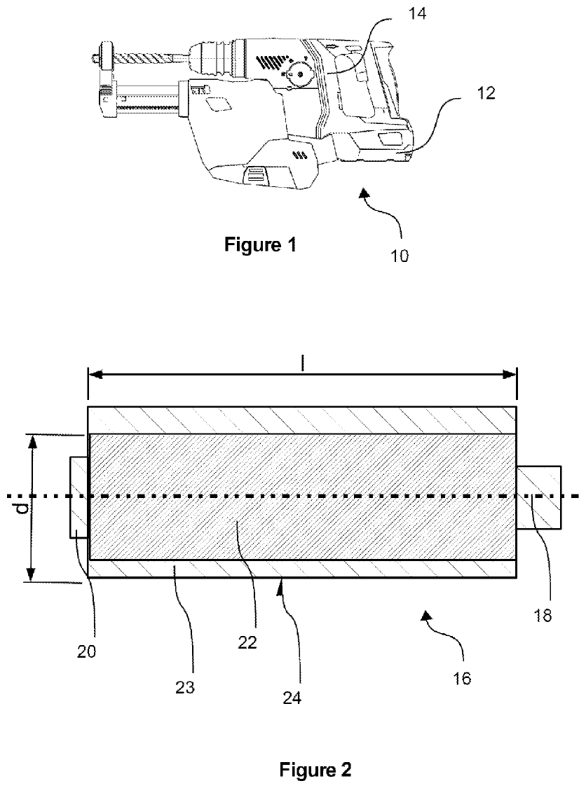

FIG. 1 shows a machine tool;

FIG. 2 shows a longitudinal section through a rechargeable battery;

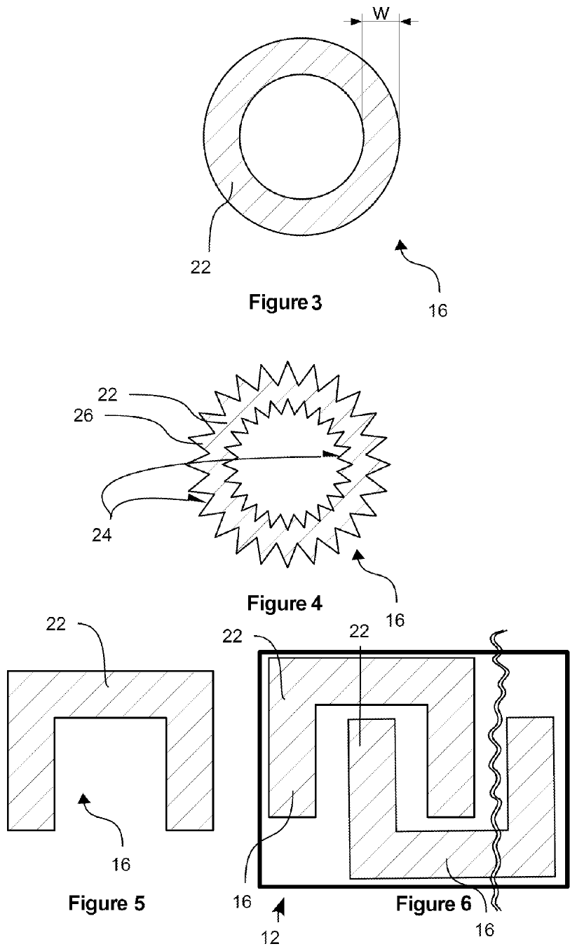

FIG. 3 shows a cross section through a further rechargeable battery;

FIG. 4 shows a cross section through a further rechargeable battery;

FIG. 5 shows a cross section through a further rechargeable battery; and

FIG. 6 shows a battery pack.

In order to make it easier to understand the invention, the same reference signs are used in each case for identical or functionally equivalent elements in the following description of the figures.

FIG. 1 shows a machine tool 10. The machine tool 10 is configured as a mobile machine tool. The machine tool 10 is, for example, an electropneumatic hammer drill. The machine tool 10 enables a cordless operation. To this end, said machine tool 10 has a rechargeable battery pack 12. The rechargeable battery pack 12 is disposed so as to be removable on a housing 14 of the machine tool 10. Said rechargeable battery pack 12 can thus be removed from the machine tool 10, for example for charging. Subsequently said rechargeable battery pack 12 can then be disposed again on the machine tool 10 so that work can continue with the machine tool 10.

FIG. 2 shows a rechargeable battery 16 in a longitudinal sectional illustration. The rechargeable battery 16 has a length l and a diameter, in particular a largest diameter d. The rechargeable battery 16 has a cylindrical shape. There are electrodes configured on both head ends 18, 20 thereof. The rechargeable battery 16 can be charged and/or discharged via the electrodes 18, 20.

The rechargeable battery 16 can have an elongate shape. To this end, the length of said rechargeable battery 16 can be at least 5 times, for example at least 10 times, as long as the diameter d.

The length l of the rechargeable battery is 0.4 m. Its diameter d is 1 cm, for example. The length l can be at least 10 cm, for example.

In this rechargeable battery 16, the ratio of the surface area of the rechargeable battery 16 to its volume is more than ten times the reciprocal of the cube root of the volume, the ratio being in particular approximately 13.

The rechargeable battery 16 furthermore has a cell core 22. The cell core 22 is surrounded by a housing 23.

Due to the cylindrical shape of the rechargeable battery 16 in conjunction with its relatively small diameter d, there is no point inside the rechargeable battery 16, in particular in the cell core 22 of the rechargeable battery 16, that is at a distance of more than 5 mm from a surface 24 of the rechargeable battery. Alternatively, it is conceivable that the rechargeable battery 16 has a non-cylindrical shape. For example, said rechargeable battery 16 and/or the cell core 22 can be cuboid or at least substantially cuboid. The term “substantially” can exclude a peripheral region of the rechargeable battery 16, or of the cell core 22, respectively.

In particular, the rechargeable battery 16 and/or the cell core 22 can be plate-shaped.

The rechargeable battery 16 is a lithium-ion battery. In particular, the cell core 22 comprises lithium for this purpose.

Said rechargeable battery 16 has a capacity of at least 2.5 Ah.

It is also conceivable that the length l is more than 40 cm, for example 0.5 m. With a diameter d of 1 cm, this results in a longitudinal sectional area of the rechargeable battery 16 of at least 40 cm².

Further exemplary embodiments of rechargeable batteries 16 are described below. Unless otherwise described, these further exemplary embodiments can have one or more features of the other rechargeable batteries 16, in particular of the exemplary embodiment described above.

Another rechargeable battery 16 is shown in a cross-sectional illustration in FIG. 3. In the cross-sectional illustration according to FIG. 3 it can be seen that the rechargeable battery in this embodiment has an annular cross section. The wall thickness w of this rechargeable battery is at most 1 cm, so again no point within the cell core 22 is at a distance of more than 5 mm from a surface of the rechargeable battery 16.

Another rechargeable battery 16 is likewise shown in a cross-sectional illustration in FIG. 4.

The rechargeable battery 16 again has a tubular cross section. In this exemplary embodiment, one or more spikes 26 is/are configured in the cross section. By way of example in FIG. 4, a spike 26 is provided with a reference sign. As a result of the spikes 26, the surface area 24 can be enlarged in relation to the space required by the rechargeable battery 16, in comparison to a tubular cross section without spikes 26.

If cell core 22 is configured from an elastically and/or plastically deformable material and/or an elastically and/or plastically deformable material composition, the rechargeable battery 16 according to this exemplary embodiment can be achieved by uniformly folding the flexible material, or the flexible material composition, respectively, in particular in accordance with the number of spikes.

A sheet-like material can be used as the initial material, or a sheet-like material composition can be used as the starting material composition, in the process.

Alternatively or additionally, it is conceivable that at least one cooling fin is arranged on the surface 24.

FIG. 5 shows a further embodiment of a rechargeable battery 16.

This rechargeable battery 16 has a U-shaped or at least substantially U-shaped cross section. This cross section can also be produced by suitably folding a sheet-like material or a sheet-like material composition, respectively. The wall thickness w of this rechargeable battery 16 is again at most 1 cm. Thus, in turn, each point of the cell core 22 is at a distance of at most 5 mm from a surface of the rechargeable battery 16.

FIG. 6 shows a rechargeable battery pack 12. The rechargeable battery pack 12 has a multiplicity of rechargeable batteries 16, for example 20, 25, or 90.

For reasons of simplification, FIG. 6 only shows two rechargeable batteries 16. By way of example, the rechargeable batteries 16 correspond to the exemplary embodiment according to FIG. 5. Alternatively or additionally however, said rechargeable batteries 16 may have a different design, in particular they may correspond to one of the exemplary embodiments according to FIGS. 1 to 4.

The rechargeable batteries 16 are disposed in a space-saving manner within the rechargeable battery pack 12. By way of example, to this end two rechargeable batteries 16 are disposed in an interlocking manner in FIG. 4, such that intermediate spaces can remain between said rechargeable batteries 16. The intermediate spaces can be specified to improve heat dissipation, in particular from surfaces of the rechargeable batteries 16.

### LIST OF REFERENCE SIGNS

10 Machine tool
12 Rechargeable battery pack
14 Housing
16 Rechargeable battery
18 Electrode
20 Electrode
22 Cell core
23 Housing
24 Surface
26 Spike
d Diameter
l Length
w Wall thickness

1. A rechargeable battery for a machine tool, the rechargeable battery having a non-cylindrical shape, having a cell core, no point within the cell core being at a distance of more than 5 mm from a surface of the rechargeable battery, and the rechargeable battery having a capacity of at least 2.2 Ah.

2. The rechargeable battery as claimed in claim 1, wherein the rechargeable battery contains lithium.

3. The rechargeable battery as claimed in claim 1, wherein a sectional area of the rechargeable battery is at least 20 cm².

4. The rechargeable battery as claimed in claim 1, wherein a ratio of surface area of the rechargeable battery to volume of the rechargeable battery is at least ten times greater than a reciprocal of a cube root of the volume.

5. The rechargeable battery as claimed in claim 1, wherein the rechargeable battery has a cylindrical shape.

6. The rechargeable battery as claimed in claim 1, wherein the rechargeable battery is specified to provide a discharge current of at least 20 A over at least 10 s.

7. The rechargeable battery as claimed in claim 1, wherein the rechargeable battery can provide at least 50 A for at least 1 s.

8. A rechargeable battery pack for a machine tool, comprising at least two rechargeable batteries as claimed in claim 1.

9. A machine tool, comprising at least one rechargeable battery as claimed in claim 1 and/or at least one rechargeable battery pack as claimed in claim 8.

10. The rechargeable battery as claimed in claim 1, having a capacity of at least 2.5 Ah.

11. The rechargeable battery as claimed in claim 3, wherein the sectional area is at least 40 cm².

12. The rechargeable area as claimed in claim 5, wherein the cell core has a cylindrical shape.

13. The rechargeable battery as claimed in claim 2, wherein a sectional area of the rechargeable battery is at least 20 cm².

14. The rechargeable battery as claimed in claim 2, wherein a ratio of surface area of the rechargeable battery to volume of the rechargeable battery is at least ten times greater than a reciprocal of a cube root of the volume.

15. The rechargeable battery as claimed in claim 2, wherein the rechargeable battery has a cylindrical shape.

16. The rechargeable battery as claimed in claim 2, wherein the rechargeable battery is specified to provide a discharge current of at least 20 A over at least 10 s.

17. The rechargeable battery as claimed in claim 2, wherein the rechargeable battery can provide at least 50 A for at least 1 s.

18. A rechargeable battery pack for a machine tool, comprising at least two rechargeable batteries as claimed in claim 2.

19. A machine tool, comprising at least one rechargeable battery as claimed in claim 2 and/or at least one rechargeable battery pack as claimed in claim 8.

20. The rechargeable battery as claimed in claim 10, wherein the rechargeable battery contains lithium.
